(19) United States
(12) Patent Application Publication
(10) Pub. No.: US 2025/0105374 A1
(43) Pub. Date: Mar. 27, 2025

(54) BATTERY

(71) Applicant: Robert Bosch GmbH, Stuttgart (DE)

(72) Inventors: Joachim Joos, Gerlingen (DE); Walter Von Emden, Eningen Unter Achalm (DE)

(21) Appl. No.: 18/727,977

(22) PCT Filed: Jan. 10, 2023
(86) PCT No.: PCT/EP2023/050370

§ 371 Date: Aug. 26, 2024

(30) Foreign Application Priority Data
Jan. 14, 2022 (DE) 10 2022 200 345.4

(51) Int. Cl. H01M 10/42; H01M 10/48; H01M 50/204; H01M 50/51; H02J 7/00

(52) U.S. Cl. CPC H01M 10/425; H01M 10/482; H01M 10/486; H01M 50/204; H01M 50/51; H01M 2010/4271; H02J 7/0014; H02J 7/0047

(57) ABSTRACT

A battery. The battery includes: a first battery-cell assembly and a second battery-cell assembly, which each have a battery cell, a first switch and a second switch; and at least one analysis unit. In each battery-cell assembly, the first switch is connected in series with the battery cell, and the second switch is connected in parallel with the series connection consisting of the battery cell and its associated first switch. The battery-cell assemblies are connected in series. The analysis unit is configured to control, at a first predefined point in time, the first switch so that it opens and the second switch so that it closes, to electrically disconnect the battery-cell assembly from each of the other battery-cell assemblies of the battery and to bypass the battery-cell assembly.

### FIELD

The present invention relates to a battery and, in particular, to a battery having a state monitoring function.

### BACKGROUND INFORMATION

Batteries are described in the related art that, for example, monitor the state of the batteries by means of a central battery management system and suitable sensors. Here, for example, voltages, currents, pressures and temperatures of the battery are monitored in order to be able to recognize the state and possible fault states of the battery.

In the related art, such monitoring is generally effected in relation to an entirety and/or a larger grouping of interconnected battery cells of the battery.

### SUMMARY

The present invention provides a battery that comprises at least a first battery-cell assembly and a second battery-cell assembly, wherein the at least two battery-cell assemblies each case have at least one battery cell, a first switch and a second switch. In principle, the battery according to the present invention can be used in any area of application, but it is particularly advantageous, for example, as a traction battery for an electrically powered vehicle (for example, a car, truck, electric bus, electric shuttle, etc.).

The first and second switches represent logical switches here, which in specific configurations can be composed of one or more physical switches (for example, in the form of a “back-to-back” assembly of two physical switches in each case). The configuration of the switches is not restricted to a specific switch type or a specific switch technology, so that the switches can be formed, for example, as electronic switches such as MOSFETs, Si-MOSFETs, SiC-MOSFETs, etc., and/or as electromechanical switches such as contactors, relays, etc. It is also possible that the respective first switches and second switches are identical or different switch types.

The at least one battery cell contains the actual electrical energy storage device and is also not restricted to a specific design (for example, a round cell, prismatic cell, pouch cell, etc.) and/or technology (for example, lithium-ion cells, lead cells, etc.).

The battery also has at least one analysis unit which is designed, for example, as an ASIC, FPGA, processor, digital signal processor, microcontroller, analog circuit, discrete and/or integrated circuit or the like.

In each battery-cell assembly, the relevant first switch is connected in series with the battery cell of the battery-cell assembly, while the relevant second switch is connected in parallel with the series connection consisting of the battery cell and its relevant associated first switch. Furthermore, the relevant battery-cell assemblies are connected in series with one another so that they each contribute to a total voltage and a total capacity of the battery.

The at least one analysis unit of the battery is connected in terms of information technology to the control inputs of the respective first and second switches and is thus designed to control the switches of the relevant battery-cell assembly independently of the switches of each of the other battery-cell assemblies. The first switch and the second switch within a battery-cell assembly are also preferably controlled independently of one another.

The analysis unit is also designed to, at a first predefined point in time, control the first switch of a battery-cell assembly currently to be checked so that it opens and the second switch of this battery-cell assembly so that it closes, in order to electrically disconnect this battery-cell assembly from the respective other battery-cell assemblies of the battery and to bypass this battery-cell assembly with regard to the series connection from the battery-cell assemblies. By bypassing, it is ensured that the remaining array of battery-cell assemblies or the battery cells contained therein can continue to be actively used within the battery.

The analysis unit is further designed to record a first voltage value, which represents an electrical voltage that is present at the battery-cell assembly to be checked at the first point in time, and to record a second voltage value, which represents an electrical voltage that is present at the battery-cell assembly to be checked at a second predefined point in time following the first point in time, by means of a voltage sensor formed of any design in principle.

On the basis of the first voltage value, the second voltage value, the first point in time and the second point in time, the analysis unit is able to determine the state of the battery-cell assembly to be checked. Here, the effect is used that a curve of the voltage that drops across the battery-cell assembly after electrical decoupling from the battery cell array is different depending on the respective boundary conditions affecting the battery-cell assembly, so that corresponding information with respect to the state of the decoupled battery-cell assembly can be determined on the basis of the respective voltage curves.

Finally, the analysis unit is designed to, at a third predefined point in time, control the first switch of the battery-cell assembly to be checked so that it closes and the second switch of this battery-cell assembly so that it opens, in order to actively use the at least one battery cell of the respective battery-cell assembly within the battery again. Active use within the battery is to be understood to mean that the previously decoupled battery-cell assembly is reintegrated into the battery cell array of the battery in this state and thus contributes to the total voltage and total capacity of the battery.

Using the battery according to the example embodiment of the present invention described above has the advantage, among other things, that individual battery cells or battery cells grouped in individual battery-cell assemblies can be measured separately, i.e., without being influenced by other battery cells and/or by a circuit technology of the battery, so that particularly accurate and reliable measurements with respect to the decoupled battery-cell assembly are possible. In addition, measurement is possible while the battery is in operation, since the respective decoupled battery-cell assembly within the battery is bypassed and the remaining battery-cell assemblies of the battery can still be actively used to absorb and/or store and/or release electrical energy in this state. In particular when using a higher number (for example, greater than 10, greater than 50 or greater than 100) of battery-cell assemblies connected in series, which together generate a total voltage of the battery, the decoupling of a battery-cell assembly to be checked during operation of the battery is hardly significant, since the influence on the total voltage or the total capacity of the battery is correspondingly low.

It should be noted that it is also possible to decouple more than one battery-cell assembly from the battery cell array at the same time, to bypass them and to measure them, depending on the respective configuration of the battery and the respective area of application of the battery. Furthermore, a combination of battery-cell assemblies that can be decoupled at the same time is generally not restricted and can be specified dynamically.

It should also be noted that the control of the switches of the respective battery-cell assemblies described above is preferably carried out recurrently and alternately during operation of the battery, so that quasi-continuous monitoring of all battery-cell assemblies is possible.

Further advantages of the battery according to the present invention result from the fact that the measurement of the respective battery-cell assemblies is possible independently of the respective load situations of the battery and that respective measurements can be executed particularly promptly and are not susceptible to interference, since each battery-cell assembly has its own measurement technology and no time-delayed communication with a higher-level measuring apparatus is necessary to carry out respective measurements.

Preferred developments and example embodiments of the present invention are disclosed herein.

In an advantageous configuration of the present invention, the analysis unit is designed to determine respective first points in time and/or second points in time and/or third points in time depending on a current use of the battery. On the one hand, this can refer to the respective time intervals between the aforementioned points in time, as well as to the respective time intervals until the repetition of a measurement process for a respective battery-cell assembly using these points in time. For example, it is possible to increase the intervals between the respective measurement runs during load peaks (for example, during acceleration phases of an electric vehicle driven by means of the battery, etc.) in order to be able to access the full capacity of the battery during such load peaks.

Alternatively or additionally, it is possible to determine the respective points in time depending on an aging state of the battery and/or depending on a level of a deviation of respective states of charge of the battery cells of the battery from one another and/or depending on a required accuracy for specifying the state of the battery-cell assembly and/or depending on a temperature distribution between the battery cells of the battery. In this way, it is possible, for example, to decouple those battery cells from the battery cell array more frequently and/or for longer periods of time, which have a higher temperature and/or a lower state of charge compared to other cells, in order to equalize the respective temperature and/or state of charge between the battery cells of the battery. In other words, it is possible in this way to execute cell balancing of the battery cells at the same time as monitoring the state. It is also explicitly possible to individually specify the respective first, second and third points in time and the respective intervals between respective repetitions of these points in time for each battery-cell assembly. In addition, it is advantageously possible to adjust the respective points in time and their repetition points in time within a respective battery-cell assembly over time depending on the respective boundary conditions.

According to an example embodiment of the present invention, particularly advantageously, the analysis unit is designed to determine a state of an assembly and joining technology (for example, contact resistances of soldered and/or welded and/or bonded connections, lead resistances, etc.) of the battery-cell assembly when determining the state of the battery-cell assembly, wherein the second point in time for this is in particular up to 100 ms, preferably up to 50 ms and in particular preferably up to 1 ms after the first point in time, wherein, for this, it is also possible to explicitly use different points in time for the second point in time. In principle, it is advantageous to determine the state of the assembly and joining technology at a second point in time, which follows the first point in time with a short time interval, since the influence of the assembly and joining technology on the measured voltage curve of the battery-cell assembly is particularly pronounced during this period. Alternatively or additionally, when determining the state of the battery-cell assembly, a state of charge and/or a state of health of the at least one battery cell of the battery-cell assembly is determined, wherein the second point in time for this is in particular between 1 ms and 1000 ms after the first point in time. In this connection as well, different points in time can be used for the second point in time. As a result of the fact that, on the basis of the battery according to the present invention, the voltage values of individual battery cells are measured exactly, it is particularly advantageous to determine the current state of charge of the battery cells of the respective battery-cell assembly with high accuracy at a very early point in time after the decoupling of the respective battery-cell assembly from the battery cell array. This results from the fact that, in contrast to determining the state of charge of the battery or individual modules of the battery in the related art, it is not necessary to wait for almost the entire relaxation period (also known as the diffusion period) (for example, several hours), in order to be able to carry out a reliable determination of the state of charge. By means of a suitable extrapolation of a future voltage curve on the basis of one or more voltage values measured according to the present invention, which were measured, for example, a few seconds to a few minutes after the decoupling of the respective battery-cell assembly, a determination of the state of charge can be carried out much more rapidly in this way than in the related art, as a result of which the respective battery cells only have to be removed from the overall cell array for a short time, thus enabling a particularly high degree of flexibility in terms of time when determining the state of charge.

In a further advantageous configuration of the present invention, the analysis unit is designed to check the plausibility of a state of charge determined as described above at predefined plausibility check points in time and/or upon the presence of the predefined plausibility check conditions (for example, if the battery is not used for a longer period of time, for example for several hours) by means of a voltage measurement, the second point in time of which is within a relaxation period of the at least one battery cell or immediately follows an end of the relaxation period of the battery cell. In other words, it is possible in this way to safeguard the early determination of the state of charge on the basis of the extrapolated voltage curve by means of the conventional procedure from the related art, in that a voltage measurement to determine the state of charge is only effected at the end of the relaxation period in time periods suitable for this purpose.

According to an example embodiment of the present invention, advantageously, the analysis unit is designed to additionally determine the state of the battery-cell assembly on the basis of a current value measured immediately prior to the first point in time and/or on the basis of a characteristic map, wherein the characteristic map defines at least one relationship between voltage curves of the battery cell after a disconnection of the battery cell from a load and a state of charge and/or state of aging and/or impedances of the battery cell.

According to an example embodiment of the present invention, preferably, the state of the battery-cell assembly is determined on the basis of additional voltage values that are recorded between the first point in time and the third point in time. The higher the number of such additional voltage values, the more accurately it is possible to carry out an extrapolation of the voltage curve, as a result of which more accurate results can be achieved when determining the state of the respective battery-cell assemblies and/or less computational effort is required for the calculation (extrapolation) of the voltage curve.

A voltage sensor provided for recording the electrical voltage of the battery-cell assembly and/or a current sensor provided for recording an electrical current is particularly preferably integrated into the at least one battery cell (in an interior and/or a wall of the battery cell) and/or arranged on an outer side of the at least one battery cell. Due to the local proximity to the battery cell or battery-cell assembly to be measured, there is a particularly low susceptibility to interference and thus a particularly high measuring accuracy, since long electrical connection lines from sensors etc. to a central measuring apparatus of the battery do not have to be used.

In a further advantageous configuration of the present invention, each battery-cell assembly has a separate analysis unit, which is provided for controlling the first switches and second switches of the respective battery-cell assemblies and which is in particular designed to communicate with a higher-level central control unit, for example of a battery management system. Among other things, this offers the advantage that the processing of results of voltage and/or current and/or temperature and/or pressure measurements within a respective battery-cell assembly can be carried out directly in the battery-cell assembly itself, as a result of which, for example, a processing speed can be increased compared to the related art.

In this way, it is also possible to divide the computing load between the individual analysis units of the respective battery-cell assemblies and any central control unit that may be present, as a result of which more cost-effective computing units can be used within the analysis units and/or within the central control unit. In addition, the reaction speed to the respective measurement results can be increased, since they do not have to be initially transmitted to a central control unit initially (possibly sequentially), in particular in time-critical situations. In particular in connection with detected fault states within the respective battery-cell assemblies, a local execution of a fault reaction within the battery-cell assembly is thus possible by the respective analysis unit. It should be noted that a communication connection (for example, a bus connection or a different connection) is not only possible between the individual analysis units and any central control unit that may be present, but that the individual analysis units can also have direct communication connections with one another.

As mentioned above, it is possible that the battery-cell assemblies in each case have exactly one battery cell or at least two battery cells connected in parallel and/or two battery cells connected in series. It is also possible that different battery-cell assemblies of the battery have different configurations of battery cells.

According to an example embodiment of the present invention, advantageously, the analysis unit is designed to alternately and recurrently check a state for at least those battery-cell assemblies of the battery that are intended for active use within the battery (i.e., cells previously recognized as defective and/or redundant can be omitted here, for example) and/or to permanently deactivate and bypass the battery-cell assemblies of the battery of which the determined state does not fulfill predefined criteria within the series connection of the battery-cell assemblies. The criteria comprise, for example, compliance with a target range impedance, a target range temperature, a target range voltage, etc.

### BRIEF DESCRIPTION OF THE DRAWINGS

Exemplary embodiments of the present invention are described in detail below with reference to the figures.

FIG. 1 shows a schematic view of an example embodiment of a battery according to the present invention.

FIG. 2 shows an exemplary current and voltage curve during a measurement of a battery-cell assembly according to the present invention.

### DETAILED DESCRIPTION OF EXAMPLE EMBODIMENTS

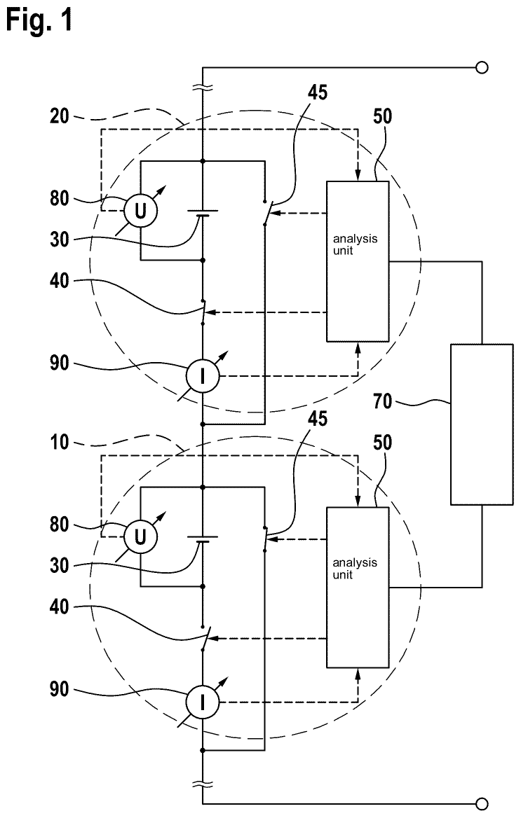

FIG. 1 shows a schematic view of an embodiment of a battery according to the present invention. The battery has a plurality (for example, 100 or more) of battery-cell assemblies 10, 20 connected in series, of which only a first battery-cell assembly 10 and a second battery-cell assembly 20 are shown here for reasons of clarity.

The battery-cell assemblies 10, 20 in each case have a battery cell 30, which is the actual electrical energy storage device, a first switch 40 and a second switch 45, wherein the respective switches 40, 45 are formed here as SiC MOSFETs.

In addition, each battery-cell assembly 10, 20 has an analysis unit 50, which is connected to the control inputs of the first switches 40 and second switches 45 in terms of information technology. In this way, the respective analysis units 50 are designed to control corresponding first switches 40 and second switches 45 independently of one another.

In the example presented here, the first switch 40 of the first battery-cell assembly 10 is opened by a control by means of the analysis unit 50 and the second switch of the first battery-cell assembly 10 is closed by a control by means of the analysis unit 50. As a result, the first battery-cell assembly 10 is electrically decoupled from the plurality of battery-cell assemblies 10, 20 of the battery, while it is electrically bypassed in the series connection of battery-cell assemblies 10, 20.

This enables an isolated voltage measurement across the first battery-cell assembly 10 by means of a voltage sensor 80, which is contained in each battery-cell assembly 10, 20. For this purpose, the respective analysis unit 50 is connected to the respective voltage sensor 80 in terms of information technology.

For the voltage measurement of the first battery-cell assembly 10, a first voltage value U1 is measured by the analysis unit 50 in conjunction with the voltage sensor 80 at a first point in time t1, which corresponds to a point in time of the opening of the first switch 40 and the closing of the second switch 45 of the first battery-cell assembly 10. At a second point in time t2, which here is 1 ms after the first point in time t1, a second voltage value U2 is measured in the same way.

On the basis of the measured voltage values U1, U2 and a time difference between the two points in time t1, t2, the analysis unit is designed to determine a state of a connection and joining technology of the battery-cell assembly.

The switches 40, 45 of the second battery-cell assembly 20 are controlled at this point in time in such a way that the second battery-cell assembly 20 is actively switched within the battery and thus contributes to a total voltage or a total capacity of the battery.

After the first battery-cell assembly 10 has been measured, the first battery-cell assembly 10 is added back to the series connection of battery-cell assemblies 10, 20 at a third point in time t3 by a control of the first switch 40 and the second switch 45, so that from this point in time onwards all battery-cell assemblies 10, 20 of the battery again contribute to a total voltage or total capacity of the battery.

Advantageously, in the course of the measurement of the first battery-cell assembly 10 described above, further voltage values U3, U4 are recorded at further points in time t4, t5 between the first point in time t1 and the third point in time t3, wherein the fourth point in time t4 here is 200 ms after the first point in time t1 and the fifth point in time t5 here is 5 s after the first point in time t1. On the basis of these additional voltage values U3, U4 and the points in time t4, t5 corresponding to them and using a characteristic map representing the properties of the first battery-cell assembly 10, a state of a cell chemistry and a state of charge of the battery cell 30 of the first battery-cell assembly 10 are also determined.

The preceding state variables of the battery cell 30 of the battery-cell assembly 10 are preferably determined recurrently and alternately with all other battery-cell assemblies 20 of the battery. A determination of respective points in time t1, t2, t3, t4, t5 and respective repetition points in time of the measurements are specified or adjusted here depending on a level of a deviation of states of charge of the battery cells 30 of different battery-cell assemblies 10, 20.

At predefined time intervals, the state of charge of the battery cell 30 determined in this way is also checked for plausibility by means of a voltage measurement at the end of a relaxation period 64 of the battery cell 30.

Preferably, a current value I1 is measured immediately prior to reaching the point in time t1 by means of a current sensor 90, which is provided in each battery-cell assembly 10, 20, and is taken into account in the course of determining the state of the first battery-cell assembly 10.

FIG. 2 shows an exemplary current flow I and a voltage curve U during a measurement of a battery-cell assembly 10, 20 according to the present invention. It should be noted that the time axis t in FIG. 2 is designed to be non-linear in order to be able to display sections of the respective curves that differ greatly in time in a single figure.

At a first point in time t1, a battery-cell assembly 10, 20 according to the present invention as described above is electrically decoupled from a series connection of a plurality of battery-cell assemblies 10, 20 and at the same time electrically bypassed. Accordingly, a current I measured within the battery-cell assembly 10, 20 drops to a value of 0 at point in time t1. Immediately prior to point in time t1, a current value I1 was measured within the battery-cell assembly 10, 20. In addition, a first voltage value U1 of the battery-cell assembly 10, 20 is measured at point in time t1.

Furthermore, at a second point in time t2, which lies within a first measurement period 60, during which predominantly a state of the connection and joining technology of the battery-cell assembly 10, 20 has an influence on the voltage curve U after the point in time t1, a second voltage value U2 is measured.

At a fourth point in time t4, which lies within a second measurement period 62, during which predominantly a state of a cell chemistry of a battery cell 30 of the battery-cell assembly 10, 20 determines the voltage curve U, a third voltage value U3 is subsequently measured.

In a subsequent third measurement period 64, which substantially corresponds to a relaxation phase of the battery cell 30, a fourth voltage value U4 is measured at a fifth point in time t5. On the basis of the preceding voltage values U1, U2, U3, U4 and their respective corresponding measurement points in time t1, t2, t4, t5, different state information about the battery-cell assembly 10, 20 is subsequently determined.

At a third point in time t3, the previously decoupled and bypassed battery-cell assembly 10, 20 is reconnected to the array of battery-cell assemblies 10, 20.

1-10. (canceled)

11. A battery comprising:
at least a first battery-cell assembly and a second battery-cell assembly, which each have at least one respective battery cell, a respective first switch, and a respective second switch; and
at least one analysis unit;
wherein:
in each battery-cell assembly of the first and second battery-cell assemblies:
the respective first switch of the battery-cell assembly is connected in series with the respective battery cell of the battery-cell assembly, and
the respective second switch of the battery-cell assemble is connected in parallel with the series connection of the respective battery cell of the battery-cell assembly and the respective first switch of the battery-cell assembly;
the first and second battery-cell assemblies are connected in series; and
the analysis unit is configured to:
control the respective first and second respective switches of each of the first and second battery-cell assemblies independently of the respective respective first and second switches of each of the other of the first and second battery-cell assemblies,
at a first predefined point in time, control the respective first switch of a battery-cell assembly currently to be checked of the first and second battery-call assemblies so that it opens and the respective second switch of the battery-cell assembly currently to be checked so that it closes, to electrically disconnect the battery-cell assembly to be checked from each of the other battery-cell assemblies of the first and second battery-cell assemblies of the battery and to bypass the battery-cell assembly currently to be checked with regard to the series connection to the other battery-cell assembly of first and second battery-cell assemblies,
record a first voltage value which represents an electrical voltage that is present at the battery-cell assembly currently to be checked at the first point in time,
record a second voltage value which represents an electrical voltage that is present at the battery-cell assembly currently to be checked at a second predefined point in time following the first point in time,
determine a state of the battery-cell assembly currently to be checked based on the first voltage value, the second voltage value, the first point in time and the second point in time, and
at a third predefined point in time, control the respective first switch of the battery-cell assembly currently to be checked so that it closes and the respective second switch of the battery-cell assembly currently to be check so that it opens, to actively use the respective battery cell of the battery-cell assembly currently to be checked within the battery.

12. The battery according to claim 11, wherein the analysis unit is configured to specify relevant first points in time and/or second points in time and/or third points in time depending upon:
a current use of the battery, and/or
an aging state of the battery, and/or
an amount of a deviation of respective states of charge of the respective battery cells of the battery, and/or
a required accuracy for determining the state of a battery-cell assembly of the first and second battery-cell assembly, and/or
a temperature distribution between the respective battery cells of the battery.

13. The battery according to claim 11, wherein the analysis unit is configured to, when determining the state of the battery-cell assembly currently to be checked:
determine a state of an assembly and joining technology of the battery-cell assembly currently to be checked, wherein the second point in time for this purpose is up to 100 ms after the first point in time, and/or
determine a state of charge and/or a state of health of the respective battery cell of the battery-cell assembly currently to be checked, wherein the second point in time for this purpose is between 1 ms and 1000 ms after the first point in time.

14. The battery according to claim 13, wherein the analysis unit is configured to check plausibility of the determined state of charge at predefined plausibility check points in time and/or upon the presence of predefined plausibility check conditions using a voltage measurement, the second point in time of which is within a relaxation period of the respective battery cell of the battery-cell assembly currently to be checked or immediately follows an end of the relaxation period of the respective battery cell of the battery-cell assembly currently to be checked.

15. The battery according to claim 11, wherein the analysis unit is configured to additionally determine the state of the battery-cell assembly based on: a current value measured immediately prior to the first point in time and/or a characteristic map, wherein the characteristic map defines at least one relationship between voltage curves of the battery cell after a disconnection of the battery cell from a load and a state of charge of the battery cell.

16. The battery according to claim 11, wherein the state of the battery-cell assembly is determined based on additional voltage values that are recorded between the first point in time and the third point in time.

17. The battery according to claim 11, wherein: (i) a voltage sensor provided for recording the electrical voltage of the battery-cell assembly and/or (ii) a current sensor provided for recording an electrical current is integrated into the at least one battery cell and/or is arranged on an outer side of the at least one battery cell.

18. The battery according to claim 11, wherein each battery-cell assembly has a separate analysis unit which is provided for controlling the respective first switches and the respective second switches of the relevant battery-cell assemblies and which is configured to communicate with a higher-level central control unit.

19. The battery according to claim 11, wherein each battery-cell assembly of the battery has:
exactly one battery cell, or
at least two battery cells connected in parallel and/or two battery cells connected in series.

20. The battery according to claim 11, wherein the analysis unit is configured to:
alternately and recurrently check a state for at least the battery-cell assemblies of the battery which are intended for active use within the battery, and/or
permanently deactivate and bypass the battery-cell assemblies of the battery of which the determined state does not fulfill predefined criteria within the series connection of the battery-cell assemblies.
